(19) United States
(12) Patent Application Publication
(10) Pub. No.: US 2013/0050129 A1
(43) Pub. Date: Feb. 28, 2013

(54) RESPONDING TO TOUCH INPUTS

(71) Applicant: Ying Liu, Beijing (CN)

(72) Inventor: Ying Liu, Beijing (CN)

(73) Assignee: NOKIA CORPORATION, Espoo (FI)

(21) Appl. No.: 13/696,036

(22) PCT Filed: May 4, 2010
(86) PCT No.: PCT/CN2010/072415

§ 371 Date: Nov. 2, 2012

(51) Int. Cl. G06F 3/048

(52) U.S. Cl. 345/173

(57) ABSTRACT

A method comprises responding to a detection of a first touch input, the first touch input being at a location on a touch-sensitive display of a device within a reference region of the touch-sensitive display associated with a hardware interface of the device, by causing an indicator associated with the hardware interface to be displayed at least partially within the reference region.

### FIELD OF THE INVENTION

This invention relates to responding to touch inputs.

### BACKGROUND OF THE INVENTION

It is known for electronic devices, such as mobile telephones, smart phones and personal digital assistants, to include one or more hardware interfaces. Examples of such interfaces include audio sockets for receiving headphones or earphones, memory card sockets for receiving removable memory cards, micro or mini USB sockets for receiving micro or mini USB connectors for connecting to external devices, power sockets for receiving connectors by which power is supplied to the device, and radio frequency transceivers such as Bluetooth transceivers for establishing wireless communication with external devices. It is also known for portable electronic devices to include touch-sensitive displays for receiving user touch inputs and for displaying information and visual content.

### SUMMARY OF THE INVENTION

A first aspect provides a method comprising responding to a detection of a first touch input, the first touch input being at a location on a touch-sensitive display of a device within a reference region of the touch-sensitive display associated with a hardware interface of the device, by causing an indicator associated with the hardware interface to be displayed at least partially within the reference region.

A second aspect provides apparatus configured to be responsive to a detection of a first touch input, the first touch input being at a location on a touch-sensitive display of a device within a reference region of the touch-sensitive display associated with a hardware interface of the device, to cause an indicator associated with the hardware interface to be displayed at least partially within the reference region.

A third aspect provides a non-transitory computer-readable storage medium having stored thereon computer-readable code, which, when executed by computing apparatus, causes the computing apparatus:
to respond to a detection of a first touch input, the first touch input being at a location on a touch-sensitive display of a device within a reference region of the touch-sensitive display associated with a hardware interface of the device, by causing an indicator associated with the hardware interface to be displayed at least partially within the reference region.

A fourth aspect provides apparatus comprising means for responding to a detection of a first touch input, the first touch input being at a location on a touch-sensitive display of a device within a reference region of the touch-sensitive display associated with a hardware interface of the device, by causing an indicator associated with the hardware interface to be displayed at least partially within the reference region.

A fifth aspect provides a method comprising:
responding to a detection of a first touch input, the first touch input being at a first location on a touch-sensitive display at which an icon is displayed, by causing an indicator associated with a hardware interface to be displayed on the display at least partially within a reference region associated with the hardware interface, the icon representing a data object; and
subsequently, responding to a detection that the first touch input is a dynamic touch input finishing at a second location, the second location being a location of the display at which the indicator is displayed, by causing an action to be performed in respect of the data object.

A sixth aspect provides apparatus configured:
to be responsive to a detection of a first touch input, the first touch input being at a first location on a touch-sensitive display at which an icon is displayed, to cause an indicator associated with a hardware interface to be displayed on the display at least partially within a reference region associated with the hardware interface, the icon representing a data object; and
subsequently, to be responsive to a detection that the first touch input is a dynamic touch input finishing at a second location, the second location being a location of the display at which the indicator is displayed, to cause an action to be performed in respect of the data object.

A seventh aspect provides non-transitory computer-readable storage medium having stored thereon computer-readable code, which, when executed by computing apparatus, causes the computing apparatus:
to respond to a detection of a first touch input, the first touch input being at a first location on a touch-sensitive display on which an icon is displayed, by causing an indicator associated with a hardware interface to be displayed on the display at least partially within a reference region associated with the hardware interface, the icon representing a data object; and
subsequently, to respond to a detection that the first touch input is a dynamic touch input finishing at a second location, the second location being a location of the display on which the indicator is displayed, by causing an action to be performed in respect of the data object.

This specification also describes machine readable code, optionally stored on a non-transitory memory medium, which when executed by at least one processor, causes the at least one processor to perform one of the above methods.

### BRIEF DESCRIPTION OF THE DRAWINGS

FIG. 1 is an electronic device according to exemplary embodiments of the invention;

FIG. 2 is a schematic representation of the components of the electronic device of FIG. 1 and their connections;

FIGS. 3A to 3D illustrate an operation performed by the device of FIG. 1 according to a first exemplary aspect of the invention;

FIGS. 4A to 4C illustrate an operation performed by the device of FIG. 1 according to the first exemplary aspect of the invention;

FIGS. 5A to 5C illustrate an operation performed by the device of FIG. 1 according to the first exemplary aspect of the invention;

FIG. 6 is a flowchart illustrating operations performed by the device of FIG. 1 according to the first exemplary aspect of the present invention;

FIGS. 7A to 7D illustrate an operation performed by the device of FIG. 1 according to a second exemplary aspect of the invention;

FIGS. 8A to 8D illustrate an operation performed by the device of FIG. 1 according to the second exemplary aspect of the invention;

FIGS. 9A to 9D illustrate an operation performed by the device of FIG. 1 according to the second exemplary aspect of the invention;

FIG. 10 is a flow chart illustrating operations performed by the device of FIG. 1 according to the second exemplary aspect of the invention;

FIGS. 11A to 11D illustrate an operation performed by the device of FIG. 1 according to a third exemplary aspect of the invention; and

FIG. 12 is a flow chart illustrating operations performed by the device of FIG. 1 according to the third exemplary aspect of the invention.

### DETAILED DESCRIPTION OF THE EMBODIMENTS

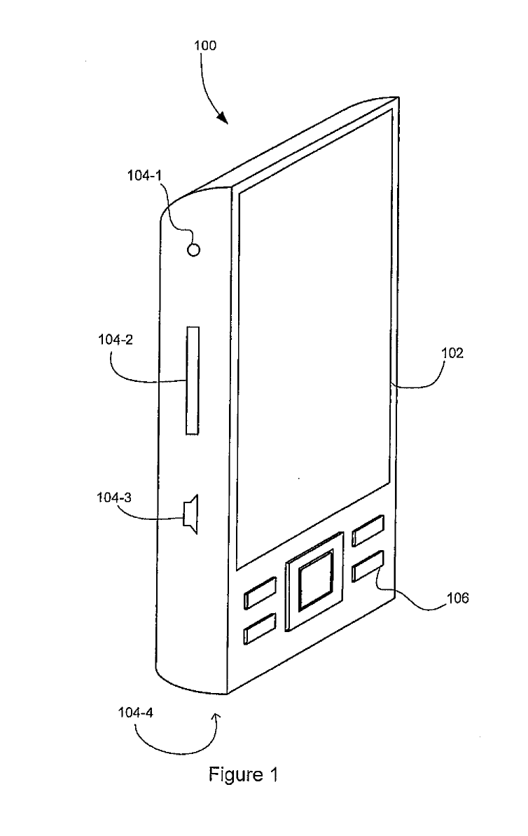

FIG. 1 depicts an example of an electronic device 100 according to exemplary embodiments of the invention. In this example, the electronic device 100 is a portable electronic device 100: a mobile telephone. The portable electronic device 100 includes a touch-sensitive display 102, and at least one hardware interface 104. The portable electronic device 100 may also comprise one or more physical keys 106 for receiving inputs from a user.

The touch-sensitive display 102 is operable to detect the incidence of touch inputs on the touch-sensitive display 102 and also to display information and content to a user of the device 100.

The portable electronic device 100 shown in FIG. 1 comprises plural hardware interfaces. Three of these interfaces can be seen on FIG. 1. A first is an audio socket 104-1 for outputting audio data to headphones and the like. A second is a memory card slot 104-2 for receiving a removable memory card (not shown). A third is a USB port 104-3 for receiving a USB connector (not shown) for connecting the portable electronic device 100 to an external device (not shown). Although not visible on FIG. 1, the portable electronic device 100 also comprises a battery charger socket 104-4 for receiving a battery charger, a SIM card slot 104-6 for receiving and connecting with a SIM card, and a Bluetooth transceiver 104-5. The battery charger socket 104-4 is at a left-hand end of the bottom surface of the device. It will be appreciated that the portable electronic device 100 may comprise more or fewer hardware interfaces than have been described with reference to FIG. 1.

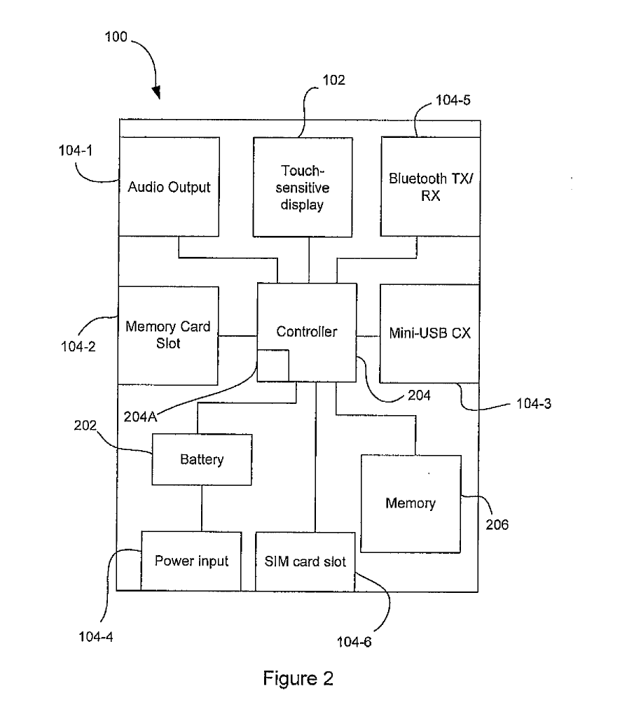

FIG. 2 is a schematic depiction showing also internal components of the device 100 of FIG. 1.

In addition to those components shown on FIG. 1, FIG. 2 shows the device 100 also comprising the Bluetooth transceiver 104-5, a battery 202 in communication with the battery charger socket 104-4 for receiving a battery charger (not shown), and a SIM card slot 104-6 for receiving a SIM card.

The portable electronic device 100 comprises a controller 204 for controlling the other components of the device 100, and a memory 206. The controller 204 is operable to provide signals for controlling the output of the touch-sensitive display 102. The controller 204 is operable also to receive signals from the touch-sensitive display 102, the signals indicating the incidence of a touch input on the touch-sensitive display 102. The controller 204 is operable to control other components of the device 100 based in part on the signals received from the touch-sensitive display 102.

The controller 204 includes one or more processors 204A. The one or more processors 204A operate under the control of computer-readable instructions, particularly an operating system and additional software, middleware or firmware modules, and software applications. The operating system and software etc. are stored on a non-transitory memory medium 206 such as ROM. The controller 204 may also comprise one or more application specific integrated circuits (ASICs) (not shown). In the following, it will be appreciated that the controller performs the stated functions and actions under the control of the computer-readable instructions.

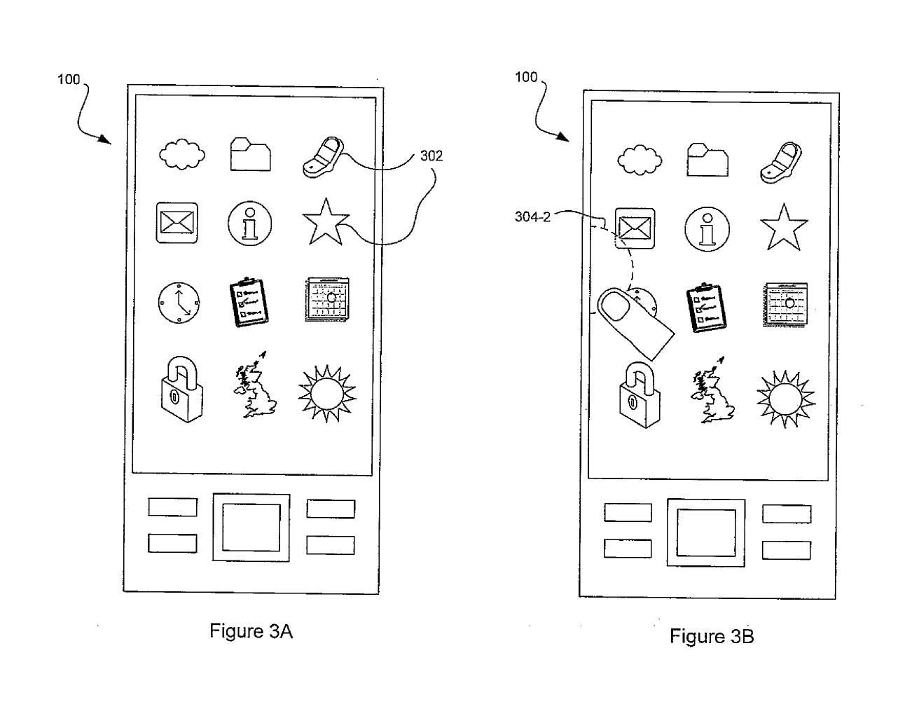

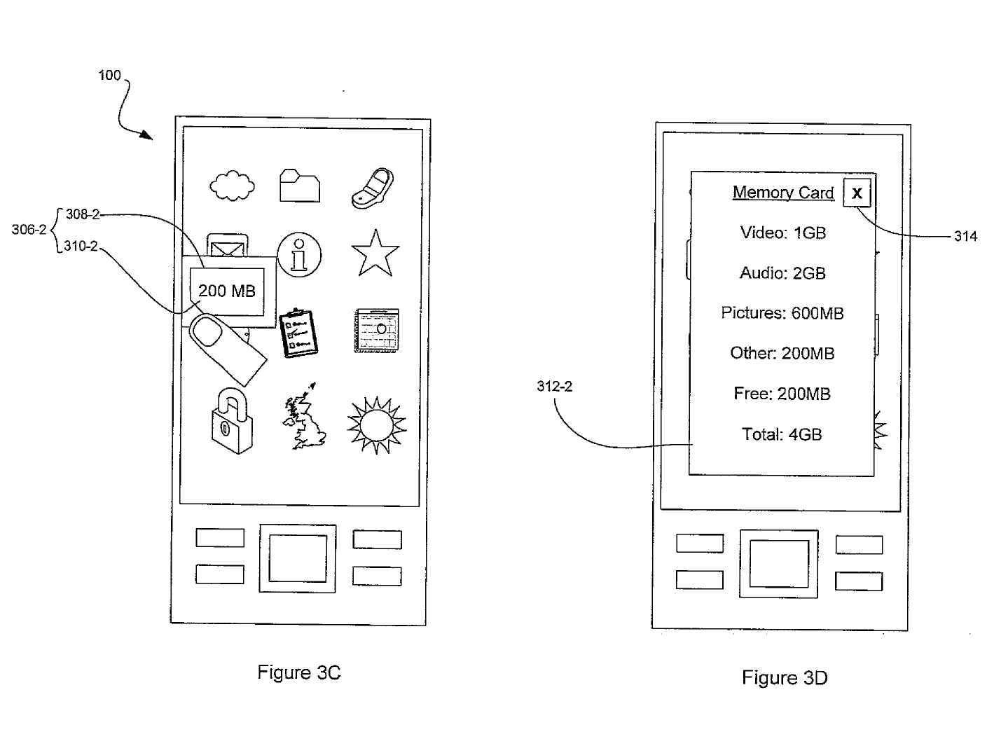

FIGS. 3, 4 and 5 illustrate exemplary operations of the device 100 of FIGS. 1 and 2 according to a first exemplary aspect of the invention.

FIG. 3A depicts the device 100 in an idle state. In this example, the idle state includes the device 100 displaying an array of selectable icons constituting a menu. The device 100 is awaiting the incidence of a touch input. An idle state includes any state in which the electronic device 100 is not receiving an input from a user. The device may be active in other ways, for example by outputting audio or receiving data.

In FIG. 3B, a touch input is incident on the touch-sensitive display 102. The controller (not shown in FIGS. 3A to 3D) determines a location of the touch input on the touch-sensitive display 102 based on signals received from the touch-sensitive display 102. The controller 204 then determines if the location of the touch input is within a reference region 304-2 associated with a one of the hardware interfaces 104. The reference region 304-2 may be at a location on the touch-sensitive display 102 that corresponds to a physical location of a hardware interface 104 on the device 100. The reference region 304-2 may be a region of the touch-sensitive display 102 that is most proximate to a physical location of a particular hardware interface 104. In the example of FIG. 3B the reference region 304-2, which is shown for illustrative purposes only as a dashed semicircle, is associated with the memory card slot 104-2. As shown in FIG. 1, the memory card slot 104-2 is at a location on the device 100 that adjacent to the middle portion of the left-hand edge of the display 102. Thus, the reference region 304-2 that is associated with the memory card slot 104-2 is substantially at a middle portion of the left-hand edge of the touch-sensitive display 102. In the example of FIG. 3B, the reference region is semi-circular. However, it will be appreciated that the reference region may instead be any other suitable shape.

FIG. 3C shows the controller responding to a detection of a touch input at a location within the reference region 304-2 by displaying an indicator 306-2 associated with the hardware interface 104-2. The indicator 306-2 is displayed on the touch-sensitive display 102 at a region which at least partially overlaps the reference region 304-2.

The indicator 306-2 may include an icon 308 which represents the hardware interface 104 with which it is associated. In this example, the reference region 304-2 within which the touch input was detected is associated with the memory card slot 104-2. Consequently, the indicator 306-2 includes an icon 308-2 which depicts a memory card.

The controller 204 may cause the indicator 306-2 to be displayed such that it appears to enter the display 102 from the edge nearest to the hardware interface 104, which in the example of FIGS. 3A to 3D is the left-hand edge. Alternatively, the indicator 306-2 may be caused gradually to un-fade, or darken, into view. According to other examples, the indicator 306-2 may be caused to appear on the display 102 in any suitable way. The indicator may be semi-transparent such that the information lying under the indicator is still partially visible through the indicator 306-2.

The indicator 306-2 includes an indication as to a status 310-2 associated with the hardware interface 104. In the example at FIG. 3C, the status 310-2 indicates an amount of free memory space that remains on a memory card (not shown) which is connected with the device 100 via the memory card slot 104-2. It will be understood that other types of status information may alternatively or additionally be displayed. For example, if a memory card is not present in the memory card slot 104-2, the status may indicate that a memory card is not connected. The indication that a particular hardware interface is or is not available may additionally or alternatively be provided by applying a different brightness or colour to the indicators of available interfaces than to unavailable interfaces. For example, unavailable indicators relating to unavailable interfaces may be caused to appear to the user as less bright than indicators relating to available interfaces.

Subsequent to displaying the indicator 306-2 associated with the hardware interface 104, the controller is operable to cause a more detailed status report 312-2 to be displayed on the touch-sensitive display 102. This is shown in FIG. 3D. The controller is operable to cause the detailed status report 312-2 to be displayed in response to detecting the occurrence of a particular tactile event. The tactile event may comprise, for example, a single tap or a double tap touch input being provided to the touch-sensitive display 102 on a region on which the indicator 306-2 is displayed. Alternatively, the tactile event may comprise the provision of a continuous touch input, having a duration in excess of a predetermined duration, to a region of the display 102 on which the indicator 306-2 is provided.

According to some exemplary embodiments, the controller may be operable to allow a user to select a selectable option from the detailed status report 312 to view a more specific status report. For example, the user may provide a touch input to the word “video” to view more detailed information regarding to the video data stored on the memory card. The user may also cause the detailed status report 312 to be closed by selecting a close icon 314 associated with the detailed status report 312. Alternatively, the controller 204 may cause the detailed status report 312 to be closed automatically. For example, the controller may cause the detailed status report 312 to be closed if no tactile input is detected within an area of the status report 312 for a predetermined period of time.

If the user does not wish to view the detailed status report 312, they may apply a touch input to a location on the display which does not correspond to the indicator. In response to detecting this input, the controller 204 causes the indicator 306-2 to disappear. Alternatively, controller 204 may cause the indicator to disappear in response to detecting that no tactile input is received within a predetermined period.

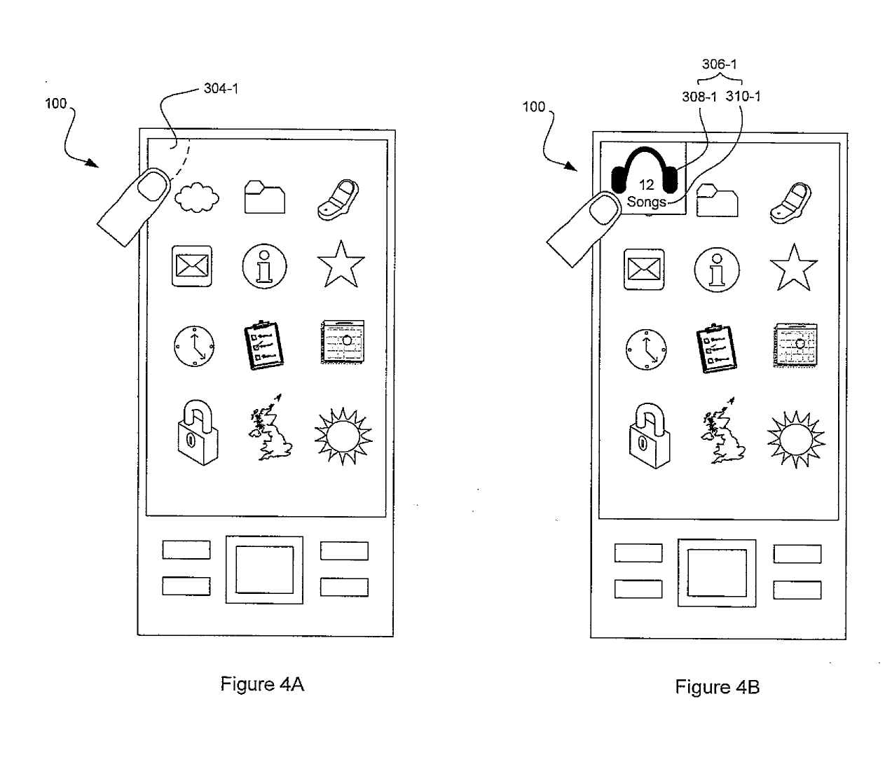

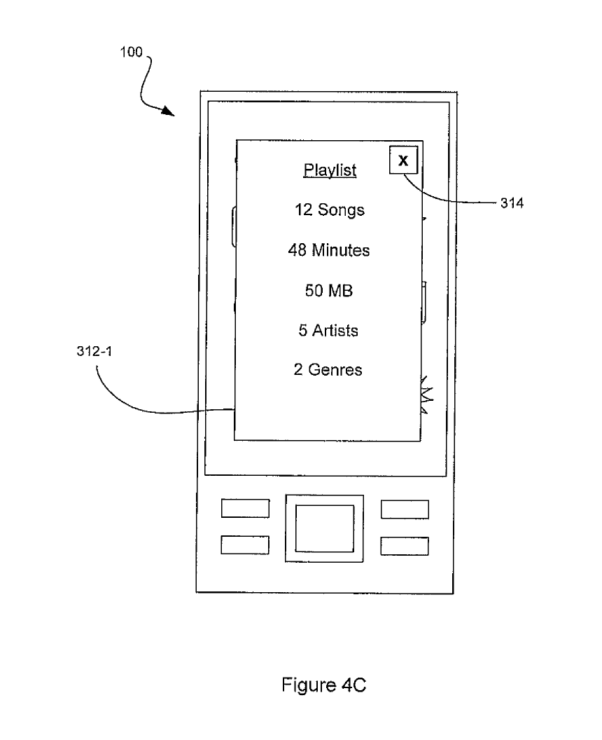

FIGS. 4A to 4C depict another operation according to the first exemplary aspect of the invention. In FIG. 4A, a touch input is incident on a reference region 304-1 at the top left of the touch-sensitive display 102. The reference region 304-1 is associated with the audio output socket 104-1, to which it is most proximate.

In FIG. 4B, having detected a touch input at a location within a reference region 304-1, the controller 204 causes an indicator 306-1 to be displayed. The indicator 306-1 is associated with the hardware interface 104-1. In the example of FIG. 4B, the indicator 306-1 includes an icon 308-1 representing the audio output socket 104-1, which is in this case an image of a pair of headphones. The indicator 306-1 also includes a status 310-1 associated with the audio output socket 104-1. In this example, the status 310-1 relates to the number of songs listed in a playlist stored on the device 100. It will be appreciated, however, that other types of status information may alternatively, or additionally, be displayed.

As is shown in FIG. 4C, the controller 204 is operable to allow a user to cause a more detailed status report 312-1 associated with the hardware interface 104-1 to be displayed. The controller 204 may be responsive to the occurrence of a tactile event to cause the more detailed status report 312-1 to be displayed. The tactile event may be the same as those described above with reference to FIG. 3A to 3D.

As described with reference to FIG. 3D, the controller 204 may be operable to cause more specific status information to be displayed in response to determining the occurrence of a touch input provided to an area of the detailed status report 312-1.

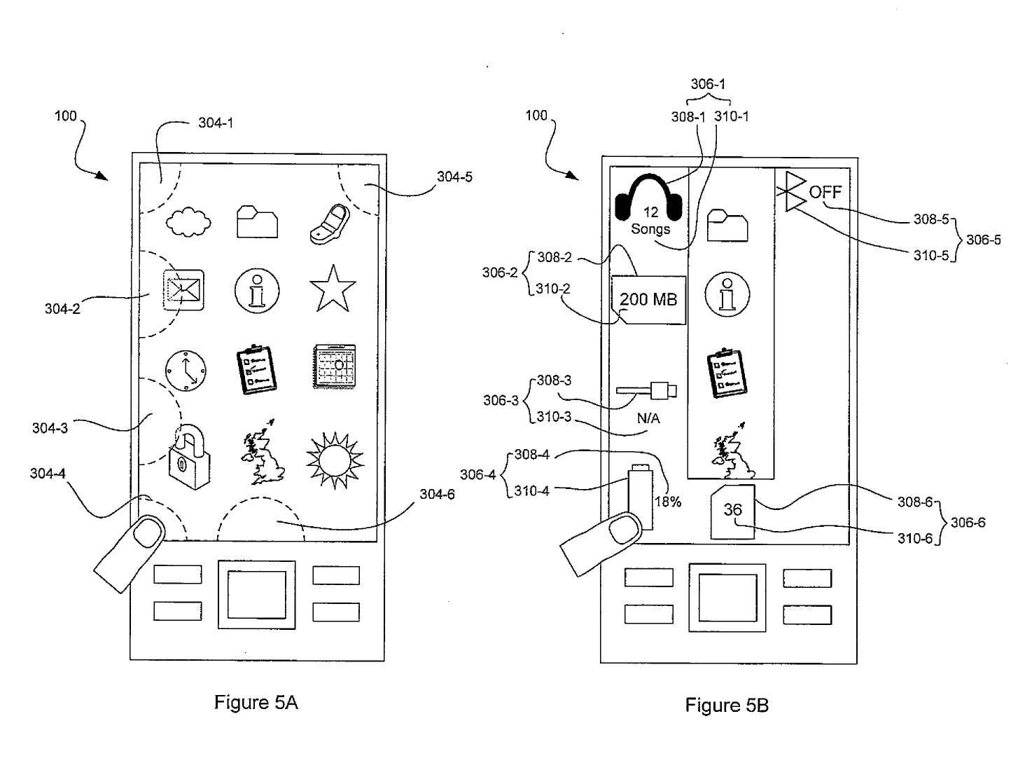

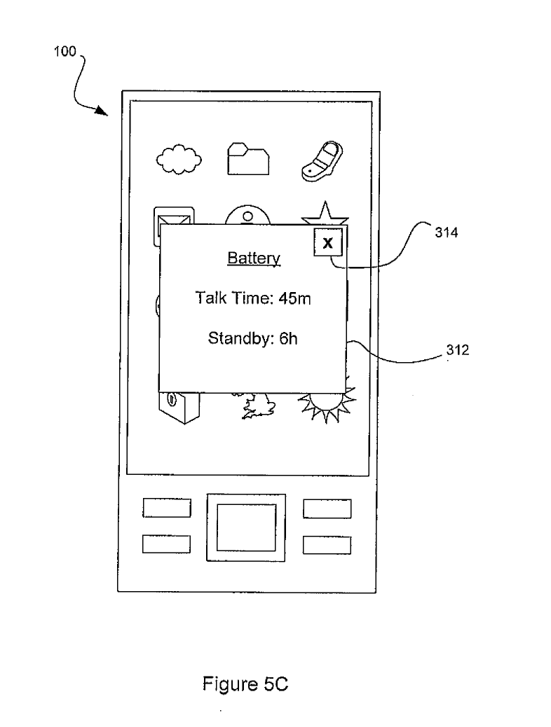

FIGS. 5A to 5C illustrate another operation according to the first exemplary aspect of the invention.

In FIG. 5A, a touch input is incident on the bottom left hand corner of the touch-sensitive display 102. In FIG. 5B, having determined that the touch input falls within a reference region 304-4 associated with a hardware interface 104-4, the controller 204 causes plural indicators 306, each associated with a different hardware interface 104, to be displayed on the touch-sensitive display 102. Each of the indicators 306 is displayed on a region of the display 102 at least partially overlapping their respective reference region 304. The reference region 304-4 to which the touch input is incident is associated with the battery charger input 104-4. The indicator 306-4 thus includes an icon 308-4 representing a battery. The indicator 306-4 also includes an indication of the status of the battery 202 of the device 100, in this case a percentage of the battery power that is remaining.

The other indicators 306 which are displayed include an indicator 306-3 associated with the USB input 104-3. The indicator 306-3 associated with the USB input 104-3 includes an icon 308-3 representing a USB connector and a status 310-3 indicating that a USB connector is not connected to the input 104-3. Also displayed are indicators 306-5, 306-6 associated with the Bluetooth transceiver 104-5 and the SIM card slot 104-6. These indicators 306-5, 306-6 each includes an icon 308-5, 308-6 and a status 310-5, 310-6 relating to the respective hardware interface 104-5, 104-6. The status 310-5 associated with the Bluetooth transceiver 104-5 indicates that the Bluetooth transceiver 104-5 is currently off. The status 310-6 associated with the SIM card slot 104-6 shows a number of contacts that are stored on a SIM card (not shown) which is in connection with SIM card slot 104-5. The indicators described with reference to FIGS. 3 and 4 are also displayed.

As can be seen in FIG. 5C, the controller 204 is responsive to detection of a tactile event in respect of one of the indicators 306 to display a detailed status report 312 in respect of the hardware interface 104 with which the indicator 306 is associated. The detailed status report 312 may include selectable option for allowing the user to view a more specific status of the hardware interface 104.

In each of the examples described with reference to FIGS. 3, 4 and 5, the controller 204 may be operable to cause the indicators to disappear if no tactile input is incident on a region of the display screen on which an indicator is displayed within a predetermined period of time. Alternatively, the controller 204 may be operable to cause the indicators 306 to disappear, or put another way is operable to cease to display the indicators, in response to determining that no touch input is incident within a predetermined duration.

According to some exemplary embodiments of the first exemplary aspect of the invention, the controller 204 may be responsive to detection of the tactile event in respect of an indicator 306 to change a status of the hardware interface 104 with which the indicator 306 is associated. For example, if the controller 204 detects the provision of a tactile event in respect of the indicator 306-5 associated with the Bluetooth transceiver 104-5 (as shown in FIG. 5B), the controller 204 may be operable to change the status of the Bluetooth transceiver 104-5 from “off” to “on”.

According to some exemplary embodiments of the first aspect of the invention, the one or more reference regions 304 may be displayed to the user. For example, an outline of the one or more reference regions 304 may be displayed on the display 102. Alternatively, the area of the display 102 corresponding to a reference region 304 may be shaded or of a different colour when compared to the remainder of the display 102.

To summarise some aspects of the above described exemplary embodiments, the device 100 comprises at least one hardware interface 104. Each of the at least one hardware interface 104 has associated with it a different region 304 of the touch-sensitive display 102. The regions are referred to herein as reference regions 304. The reference region 304 may be located at an edge of the display 102. The reference region 304 may be a region of the display 102 which is most proximate to the hardware interface with which it is associated. The location of the reference region 304 may correspond to a physical location of the hardware interface 104 with which it is associated. The controller 102 is responsive to the detection of a touch input within a reference region to cause an indicator 306 to be displayed. The indicator 306 is associated with the hardware interface 104 with which the reference region 304 associated. The indicator 306 is displayed on an area of the display 102 which at least partially overlaps with its associated reference region 304. The indicator 306 may include an icon 308, which represents the hardware interface 104 with which it is associated. The indicator 306 may include a status 310 associated with the hardware interface 104. The controller 204 is operable, in response to detecting the occurrence of a tactile event within a region of the display on which an indicator is displayed, to cause to be displayed a detailed status report 312 relating the hardware interface 104 with which the indicator 306 is associated. According to some embodiments, the controller 204 may be responsive to detection of a touch input within one reference region 304 to cause to be displayed indicators 306 associated with plural hardware interfaces 104. In such embodiments, each of the plural indicators 306 is displayed on an area of the display 102 that at least partially overlaps their respective reference region 304.

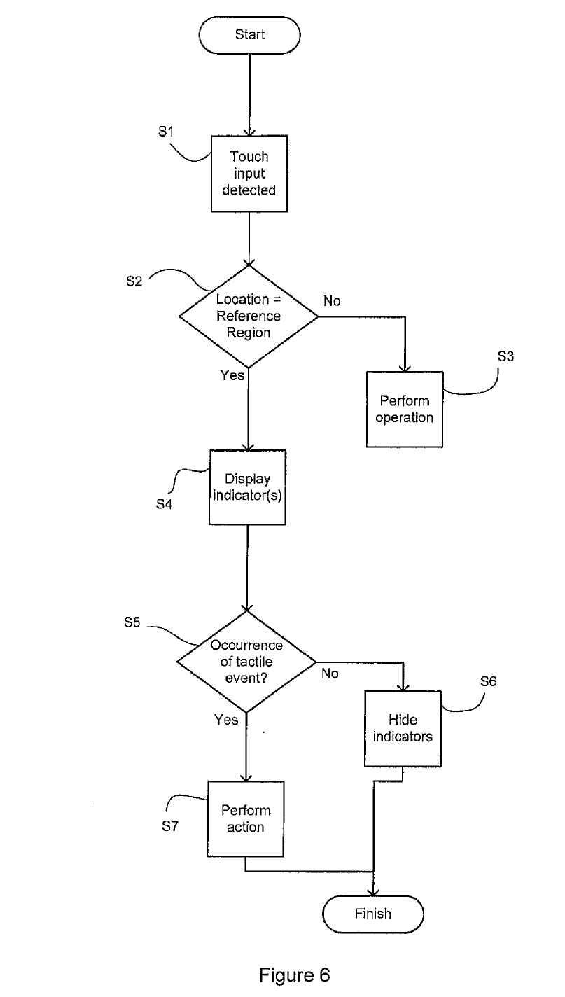

FIG. 6 is a flowchart depicting operations according to the first exemplary aspect of the invention.

In step S1, the controller 204 detects, based on signals received from the touch-sensitive display 102, the incidence of a touch input on the touch-sensitive display 102.

In step S2, the controller 204 determines whether the location of the incident touch input is within a one of the reference regions 304 associated with the hardware interfaces 104.

If, in step S2, it is determined that the location of a touch input does not fall within a reference region 304, the method proceeds to step S3. In step S3, the controller 204 causes an action associated with the touch input to be performed. The nature of this operation is not important to the invention, and may include for example the execution or opening of an application associated with a selected icon.

If, in step S2, it is determined that the location of the touch input is within a reference region 304, the operation proceeds to step S4. In step S4, an indicator 306 associated with the hardware interface 104 with which the reference region 304 is associated is displayed. Alternatively, plural indicators 306 each corresponding to a different one of plural hardware interfaces 104 is displayed at least partially within their respective reference regions 304.

Next, in step S5, it is determined if a tactile event in respect of one of the indicators 306 has occurred. As discussed above, the tactile event may include a single tap or a double tap touch input being applied to a one of the indicators 306. Alternatively the tactile event may include a touch input having been applied continuously to an indicator 306 for longer than a predetermined duration.

If, in step S5, a tactile event is not detected, the operation proceeds to step S6. In step S6, the indicator (or indicators) is hidden and the operation subsequently finishes.

If in step S5, it is determined that a tactile event has occurred, the operation proceeds to step S7 in which the controller 204 causes an action to be performed. According to some exemplary embodiments, the action may include displaying a detailed status report 312 associated with the hardware interface 104. Alternatively, the action may include changing the status 301 of the hardware interface 104, for example by turning the interface 104, such as a Bluetooth transceiver 104-5, from “off” to “on”. Subsequent to step S7 the operation finishes.

Typically, in portable electronic devices it is necessary to navigate through a complex menu in order for a user to view the status of a particular hardware interface or an entity connected to the hardware interface. The above described embodiments provides solutions that allows a user to be able easily to determine the status of a particular interface simply by moving their finger or thumb to a region of the touchscreen display that is most proximal to the hardware interface in questions. This is particularly intuitive and a user will be able to learn the physical location of the hardware interfaces on the devices and will thus be able to determine the status of an interface without a great deal of thought. Additionally, the embodiments allow a user to access information and functions with lower utilization of the hardware, particular user interface hardware, of the device 100. This can improve the reliability of the hardware and prolong its life.

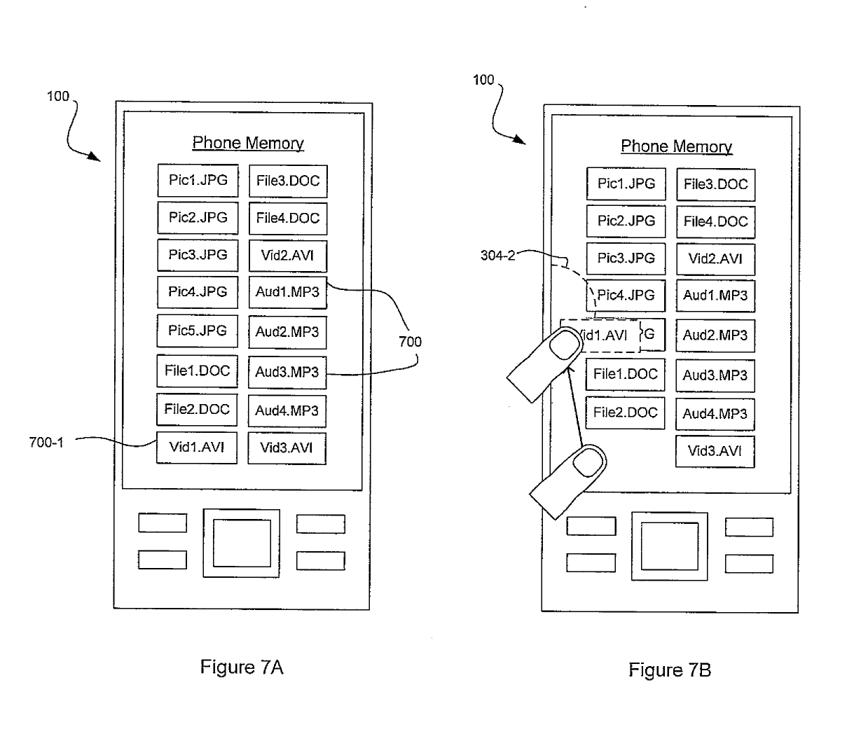

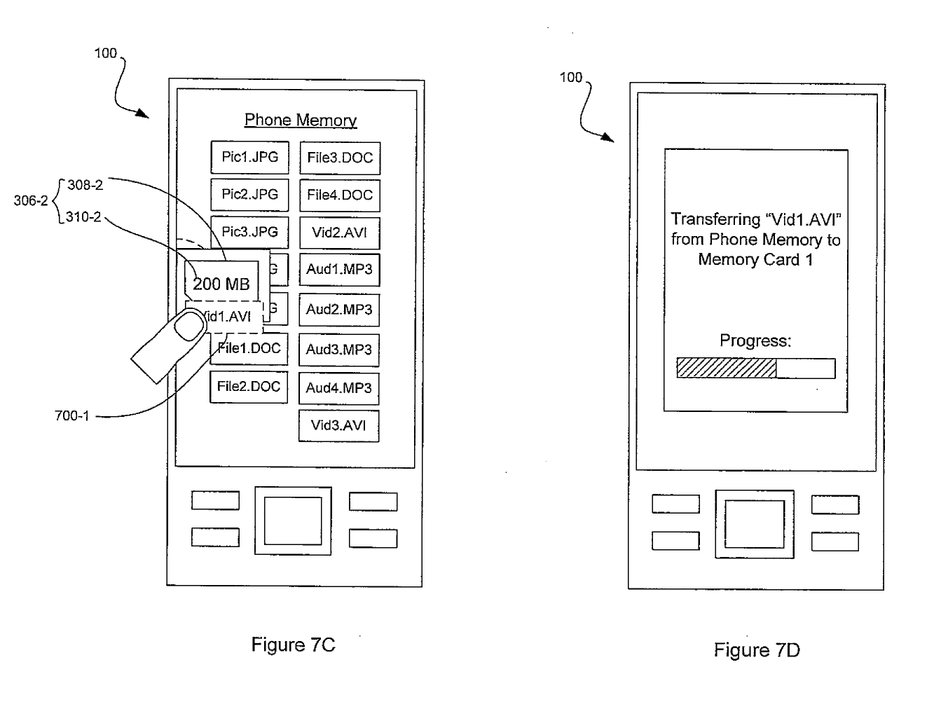

FIGS. 7, 8 and 9 illustrate exemplary operations carried out by the device of FIGS. 1 and 2 according to a second exemplary aspect of the invention.

In FIG. 7A, a list of files, or data objects, is being displayed on the touch-sensitive display 102. These files are, for example, stored on an internal memory, such as memory 206, of the portable electronic device 100. Each data object is represented in the list as an icon 700.

In FIG. 7B, the user applies a touch input to an initial location which falls within a one of the icons 700-1, which is in this example “Vid1.AVI”. Next, the user drags their finger from the initial location towards a location of the screen that is proximate to the memory card slot 104-2. A touch input such as this, i.e. when a finger is dragged across the surface of the touch sensitive display, can be referred to as a dynamic touch input. In response to detecting the incidence of a dynamic touch input from an initial location corresponding to an icon 700-1, the controller 204 causes the icon to appear to be dragged across the touch sensitive display 102 in the direction of movement of the dynamic touch input.

As shown in FIG. 7C, the controller 204 is responsive to detecting that the finger is incident at a location on the screen that falls within a reference region 304 associated with a one of the hardware interfaces 104 by causing an indicator 306-2 associated with the hardware interface 104, in this case the memory card slot 104-2, to be displayed. The indicator 306-2 is displayed on an area of the display 102 which at least partially overlaps with its associated reference region 304-2. The controller 204 may cause the indicator 306 to be displayed such that it appears to enter the display 102 from the edge neatest to the hardware interface 104, which in the example of FIGS. 7A to 7D is the left-hand edge. Alternatively, the indicator 306-2 may be caused gradually to un-fade, or darken, into view. According to other examples, the indicator 306-2 may be caused to appear on the display 102 in any suitable way. The indicator may be semi-transparent such that the information lying under the indicator is still partially visible through the indicator 306-2. The indicator 306-2 indicates to the user that their finger is within the reference region associated with the memory card slot 304-2. The indicator 306-2 may include an icon 308-2, status information 310-2 or both.

The controller 204 is responsive to determining that the dynamic tactile input has been completed (i.e. that the user's finger has been removed from the surface of the touch-sensitive display 102) at a location falling within a reference region to transfer the data object associated with the selected icon 700-1 from its original location, such as the internal memory of the device 206, to a location associated with the hardware interface 104-2 with which the reference region 304-2 is associated. This can be seen in FIG. 7D in which the transference of the data object “Vid1.AVI” from the internal memory 206 to the memory card is illustrated on the display 102. According to some exemplary embodiments, the controller 206 may be responsive to detecting that the dynamic touch input has been completed, by asking the user to provide an input indicating whether they require the data object to be transferred before transferring the object.

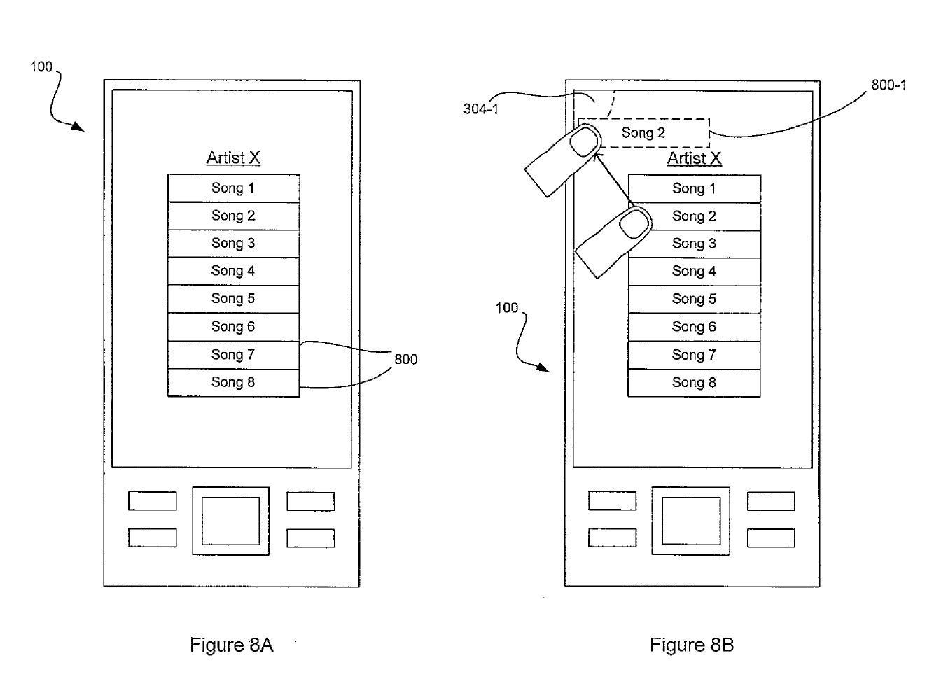

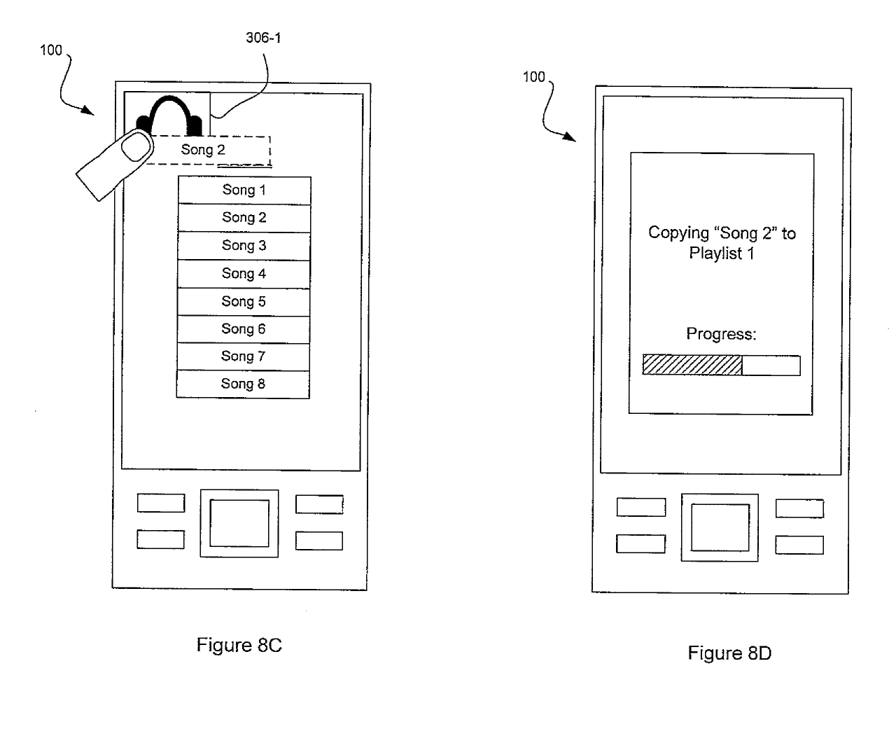

FIGS. 8A to 8D illustrate another exemplary operation according to a second aspect of the invention.

In FIG. 8A, a list of songs which are stored on memory associated with the device, such as internal memory 206 or a memory card (not shown in the Figures) is being displayed on the touch-sensitive display 102. Each song is represented in the list as an icon 800.

In FIG. 8B, the user applies a touch input to an initial location which corresponds to one of the icons 800-1, which is in this example “Song2”. Next, the user drags their finger from the initial location towards a location of the screen that is proximate to the audio output 104-1. In response to detecting the dynamic touch input from an initial location corresponding to an icon 800-1, the controller 204 causes the icon to appear to be dragged across the touch sensitive display 102 in the direction of movement of the dynamic touch input.

As shown in FIG. 8C, the controller 204 is responsive to detecting that the finger is incident at a location on the screen that falls within a reference region 304 associated with a one of the hardware interfaces 104 by causing an indicator 306-1 associated with the hardware interface, in this case the audio output 104-1, to be displayed. The indicator 306-1 is displayed on an area of the display 102 which at least partially overlaps with its associated reference region 304-1. The controller 204 may cause the indicator 306-1 to be displayed such that it appears to enter the display 102 from the edge nearest to the hardware interface 104, which in the example of FIGS. 8A to 8D is the left-hand edge. Alternatively, the indicator 306-1 may be caused gradually to un-fade, or darken, into view. According to other examples, the indicator 306-1 may be caused to appear on the display 102 in any suitable way. The indicator may be semi-transparent such that the information lying under the indicator is still partially visible through the indicator 306-1. The indicator 306-1 indicates to the user that their finger is within the reference region associated with the audio output 304-1. The indicator 306-1 may include an icon 308-2, status information 310-2 or both.

The controller 204 is responsive to determining that the tactile input has been completed (i.e. that the user's finger has been removed from the surface of the touch-sensitive display 102) at a location falling within a reference region to perform an action in respect of the data object associated with the selected icon 800-1. In this example, the controller 204 causes the song associated with the selected icon 800-1 to be added to a playlist. This may comprise copying the song from an original location to a new location associated with the playlist. Alternatively, it may comprise adding an index to the original location of the song to a file which represents the playlist. This can be seen in FIG. 8D in which the addition of the song “Song2” to the playlist is illustrated on the display 102. According to some exemplary embodiments, the controller 206 may be responsive to detecting that the dynamic touch input has been completed, by asking the user to provide an input indicating whether they require the song to be added to the playlist.

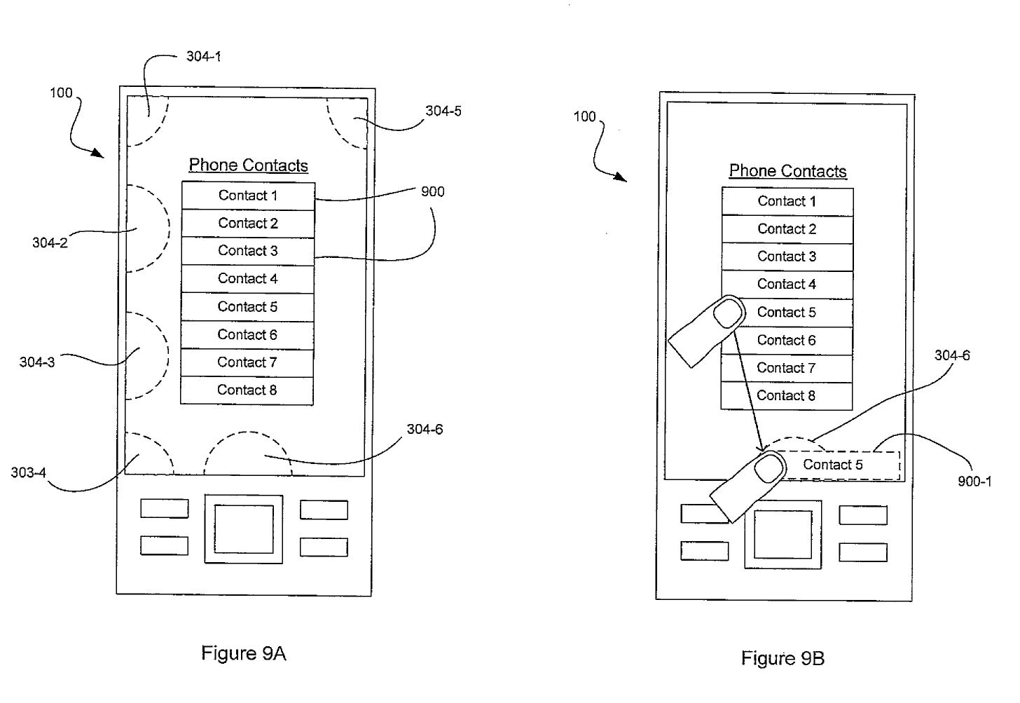

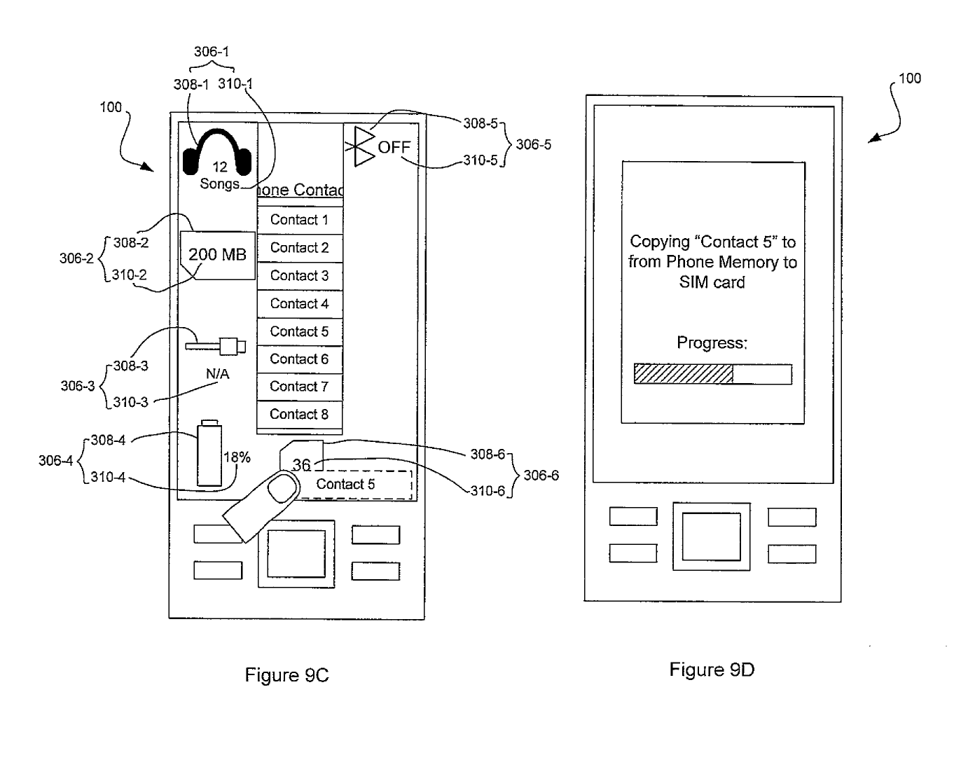

FIGS. 9A to 9D illustrate another exemplary operation according to the second aspect of the invention.

In FIG. 9A, a list of contacts is displayed on the touch-sensitive display 102. These contacts are, for example, stored on an internal memory, such as memory 206, of the portable electronic device 100. Each contact is represented in the list as an icon 900.

In FIG. 9B, the user applies a touch input to an initial location which falls within an area of the display 102 on which a one of the icons 700-1, which is in this example “Contact 5”, is displayed. Next, the user drags their finger from the initial location towards a location a reference region 304 of the display that is associated with the SIM card slot 304-6. In response to detecting the dynamic touch input from an initial location corresponding to an icon 700-1, the controller 204 causes the icon to appear to be dragged across the touch sensitive display in the direction of movement of the dynamic touch input.

As shown in FIG. 9C, the controller 204 is responsive to detecting that a touch input is incident at a location on the screen that falls within a reference region 304 associated with a one of the hardware interfaces 104 by causing indicators 306 associated with the each of the hardware interfaces 104 to be displayed. Each of the indicators 306 is displayed on a region of the display 102 at least partially overlapping their respective reference region 304. The reference region 306-6 to which the touch input is incident is associated with the SIM card slot 104-4. The indicator 306-4 includes an icon 308-4 representing a battery. The indicator 306-4 may optionally also include an indication of a status of the SIM card. In this example, the status information is a number of contacts stored on the SIM card

The other indicators 306 which are displayed include an indicator 306-3 associated with the USB input 104-3. The indicator 306-3 associated with the USB input 104-3 includes an icon 308-3 representing a USB connector and a status 310-3 indicating that a USB connector is not connected to the input 104-3. Also displayed are indicators 306-5, 306-4 associated with the Bluetooth transceiver 104-5 and the power input 104-4. These indicators 306-5, 306-4 each includes an icon 308-5, 308-4 and a status 310-5, 310-4 relating to the respective hardware interface 104-5, 104-4. The status 310-5 associated with the Bluetooth transceiver 104-5 indicates that the Bluetooth transceiver 104-5 is currently off. The status 310-4 associated with the power input 104-4 indicates a percentage of power remaining in the battery 202. Also displayed are indicators 306-2, 306-1 associated with the memory card slot 104-2 and the audio output 104-1.

The controller 204 may cause the indicators 306 to be displayed such that they appear to enter the display 102 from the edge nearest to their respective hardware interface 104. Alternatively, the indicators 306 may be caused gradually to un-fade, or darken, into view. According to other examples, the indicators may be caused to appear on the display 102 in any suitable way. The indicators 306 may be semi-transparent such that the information lying under the indicators 306 is still partially visible.

The controller 204 is responsive to determining that the dynamic tactile input has been completed (i.e. that the user's finger has been removed from the surface of the touch-sensitive display 102) at a location falling within a reference region to transfer a data object associated with the selected icon 700-1, from its original location (such as the internal memory of the device 206) to a location associated with the hardware interface 104-6 with which the reference region 304-6 is associated. This can be seen in FIG. 9D in which the transfer of the “Contact 5” from the internal memory to the SIM card is illustrated on the display 102. According to some exemplary embodiments, the controller 206 may be responsive to detecting that the dynamic touch input has been completed, by asking the user to provide an input indicating whether they require the data object to be transferred.

According to some exemplary embodiments of the second aspect of the invention, the one or more reference regions 304 may be displayed to the user. For example, an outline of the one or more reference regions 304 may be displayed on the display 102. Alternatively, the area of the display 102 corresponding to a reference region 304 may be shaded or of a different colour when compared to the remainder of the display 102.

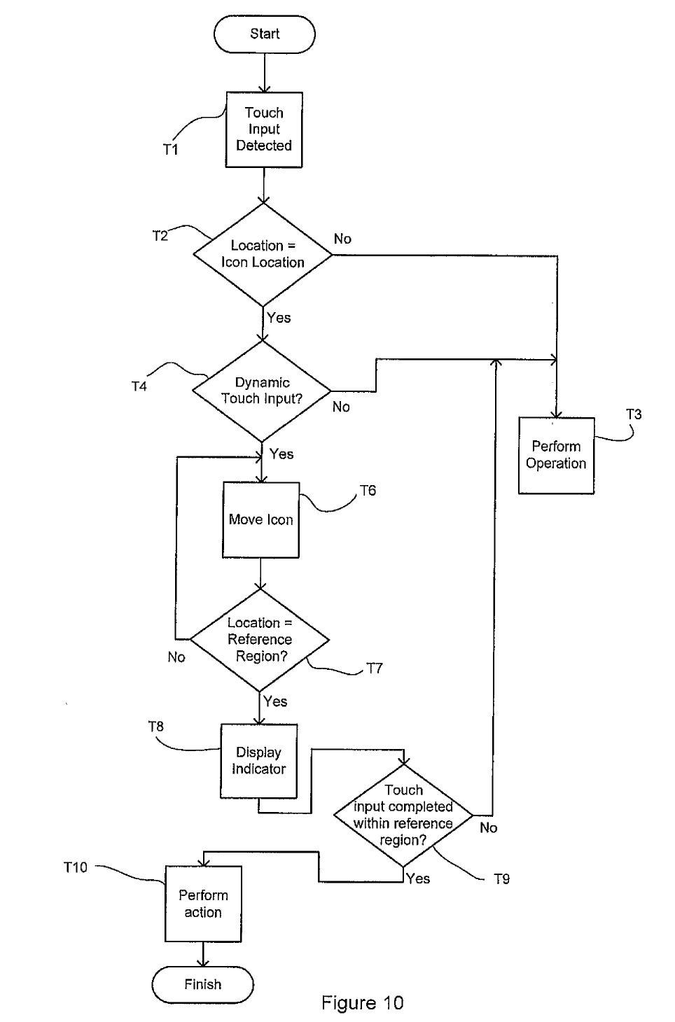

FIG. 10 is a flowchart depicting operations according to the second exemplary aspect of the invention.

In step T1, the controller 204 detects, based on signals received from the touch-sensitive display 102, the incidence of a touch input on the touch-sensitive display 102.

In step T2, the controller 204 determines whether the location of the incident touch input is within a region of the display 102 on which an icon 700, 800 is displayed.

If, in step T2, it is determined that the location of a touch input does not fall within a region on which an icon 700, 800 is displayed, the method proceeds to step T3. In step T3, the controller 204 causes an action associated with the touch input to be performed. The nature of this operation is not important to the invention.

If, in step T2, it is determined that the location of the incident touch input is within a region of the display 102 on which an icon is displayed 700, 800, the operation proceeds to step T4. In step T4, the controller 204 determines if the touch input is a dynamic touch input. This is based on signals received from the touch-sensitive display 204.

If, in step T4, it is determined that the touch input is not a dynamic touch input, the operation proceeds to step T3. In step T3, the controller 204 causes an action associated with the touch input to be performed. The nature of this operation is not important to the invention. Subsequent to step T3, the operation finishes.

If it is determined in step T4 the touch input is a dynamic touch input, the operation proceeds to step T5 in which the controller causes the icon 700, 800 to be moved, or dragged across the display 102 in the direction of the dynamic touch input.

Next, in step T6, the controller 204 determines based on signals received from the touch-sensitive display 102, whether the dynamic touch input has entered a reference region associated with a one of the plurality of hardware interfaces 104.

If it is determined in step T6 by the controller 204 that the dynamic touch input has not entered a one of the reference regions 304, the operation returns to step T5.

If in step T6, it is determined that the dynamic touch input has entered a one of the reference regions 304, the operation proceeds to step T7. In step T7, the controller 204 causes an indicator 306 associated with the hardware interface 104 with which the reference region 304 is associated to be displayed. Alternatively, plural indicators 306 each corresponding to a different one of plural hardware interfaces 104 is displayed at least partially within their respective reference regions 304.

Next, in step T8, it is determined if the dynamic tactile input is completed within the one of the reference regions 304. In other words, the controller 204 determines if the location on the display 102 to which the user's finger was incident immediately prior to it being removed from the display 102 falls within the reference region 304.

Following a positive determination in step T8, the operation proceeds to step T9 in which the controller 204 causes an operation to be performed in respect of a data object associated with the icon selected in step T5. This may include, for example, copying or transferring the data object between two locations, which may be on a different or the same memory. Subsequent to step T9, the operation finishes.

If it is determined in step T8 that the touch input is completed at a location that does not fall within a one of the reference regions 304, the operation proceeds to step T3.

Although not shown in the Figure, if the dynamic input ceases between steps T4 and T8, the method may proceed to step T3 or may alternatively finish.

To summarise the above described exemplary embodiments according to the second aspect of the invention, the device 100 comprises at least one hardware interface 104. Each of the at least one hardware interface 104 has associated with it, a different region 304 of the touch-sensitive display 102. The regions are referred to herein as reference regions 304. The reference region 304 may be located at the edge of the display 102. The reference region 304 may be a region of the display 102 which is most proximate to the hardware interface with which it is associated. The controller 102 is responsive to the detection of a dynamic touch input, the initial location of which falls within an area of the display on which an icon is displayed, to move the icon across the display in a direction of movement of the dynamic touch input. The controller 102 is responsive to detection of a dynamic touch entering a reference region 304 to cause an indicator 306 to be displayed. The indicator 306 is associated with the hardware interface 104 with which the reference region 304 associated. The indicator 306 is displayed on an area of the display 102 which at least partially overlaps with its associated reference region 304. The indicator 306 may include an icon 308, which represents the hardware interface 104 with which it is associated. The indicator 306 may include a status 310 associated with the hardware interface 104. According to some embodiments, the controller 204 may cause plural indicators 306, each associated with a different hardware interface 104 to be displayed simultaneously. The controller 204 is operable, in response to detecting that the dynamic touch input has been completed and that its final location is within a one of the reference regions 304, to cause an action to be performed in respect of a data object associated with selected icon. This action may include may include transferring or copying the data object from one location to another. For example, the data object may be copied or transferred from an internal memory to an external memory such as a memory card, from an internal memory to a SIM card, from a first SIM card to a second SIM card or from a first memory card to a second memory card. According to other examples, the action may include adding a media object such as an audio clip or a video to a playlist.

The second exemplary aspect of the invention allows a user easily to move data objects between locations on the portable device. Normally, this requires navigation of complex menu systems. As such, these embodiments allow a user to access information and functions with lower utilization of the hardware, particular user interface hardware, of the device 100. This can improve the reliability of the hardware and prolong its life.

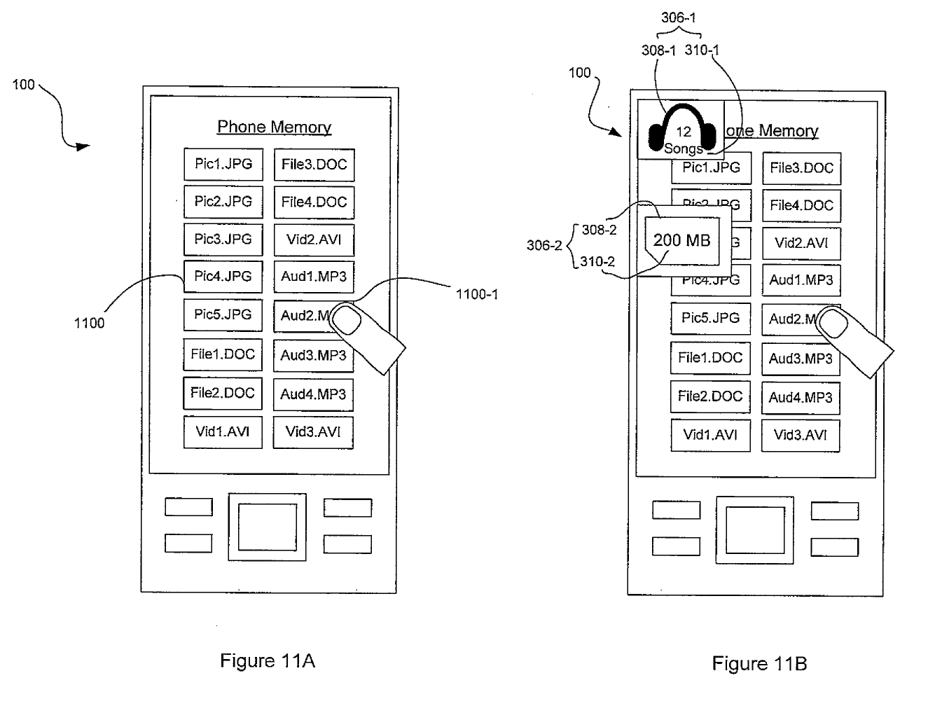

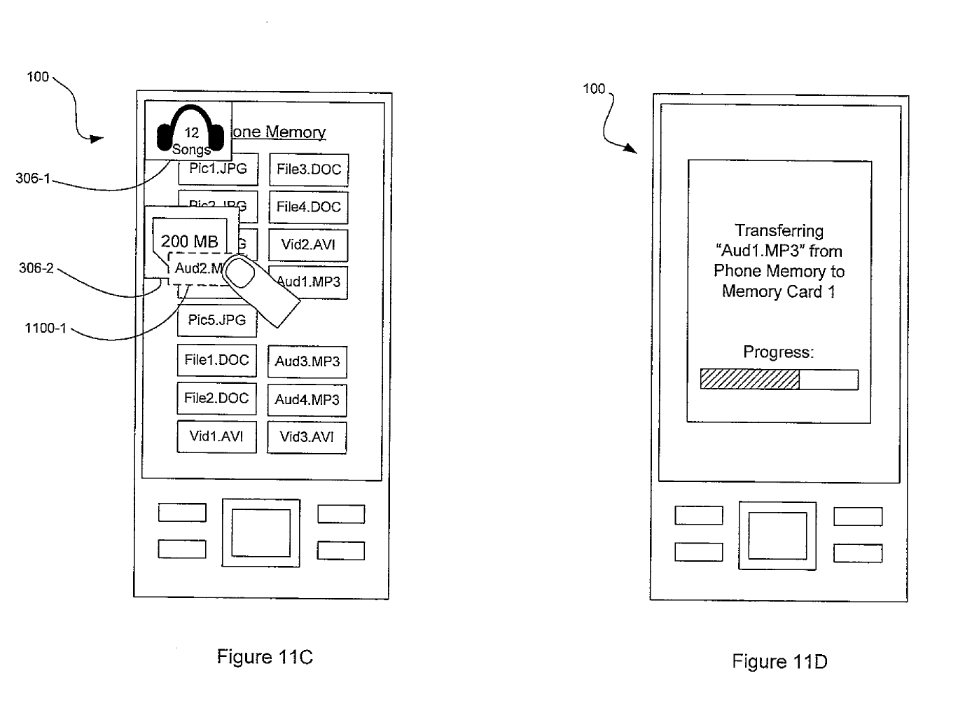

FIGS. 11A to 11D illustrate an exemplary operation carried out by the device of FIGS. 1 and 2 according to a third exemplary aspect of the invention.

In FIG. 11A, a list of files, or data objects, is being displayed on the touch-sensitive display 102. These files are, for example, stored on an internal memory, such as memory 206, of the portable electronic device 100. Each data object is represented in the list as an icon 1100. The user is applying a touch input to an initial location which falls within a one of the icons 1100-1, which is in this example “Aud2.MP3”.

FIG. 11B shows the device 100 after the touch input has been incident on the icon 1100-1 for longer than a predetermined duration. In response to detecting that the touch input has been incident on the icon 1100-1 for longer than a predetermined duration, the controller 204 causes at least one indicator 306 associated with a hardware interface 104 to be displayed. In this example, two indicators 306-1, 306-2 are caused to be displayed, one of the indicators 306-1 being associated with the audio output 104-1 and the other indicator 306-2 being associated with the memory card slot 104-2. Each of the indicators 306-1, 306-2 is displayed on an area of the display 102 which at least partially overlaps with a reference region (not shown in FIGS. 11A to 11D) that is associated the respective hardware interface 104-1, 104-2.

The controller 204 may cause the indicators 306-1, 306-2 to be displayed such that they appear to enter the display 102 from the edge nearest to the hardware interface 104, which in the example of FIGS. 11A to 11D is the left-hand edge. Alternatively, the indicators 306-1, 306-2 may be caused gradually to un-fade, or darken, into view. According to other examples, the indicators 306-1, 306-2 may be caused to appear on the display 102 in any suitable way. The indicators 306-1, 306-2 may be semi-transparent such that the information lying under the indicators is still partially visible through the indicators 306-1, 306-2.

The indicators 306-1, 306-2 include an indication as to a status 310-1, 310-2 associated with the respective hardware interfaces 104-1, 104-2. In the example of FIG. 11B, the status 310-2 associated with the memory card slot 104-2 indicates an amount of free memory space that remains on a memory card (not shown) which is connected with the device 100 via the memory card slot 104-2. The status 310-2 associated with the audio output indicates a number of songs in a playlist. It will be understood that other types of status information may alternatively or additionally be displayed.

The indicators 306-1, 306-2 may include an icon 308 which graphically represents the hardware interface 104 with which it is associated. In this example, the first indicator 306-1 includes an icon 308-1 representing a pair of headphones and the second indicator 306-2 includes an icon representing a memory card 308-2.

In FIG. 11C, the user drags their finger from the initial location towards a location of the screen at which the indicator associated with the memory card slot 104-2 is displayed. In response to detection of a dynamic touch input such as this; the controller 204 causes the icon 1100-1 to appear to be dragged across the touch-sensitive display 102 in the direction of movement of the dynamic touch input.

In response to determining that the dynamic tactile input has been completed (i.e. that the user's finger has been removed from the surface of the touch-sensitive display 102) at a location falling within a region on which the indicator is displayed, the controller 204 causes the transfer of the data object associated with the selected icon 1100-1 from the its original location, such as the internal memory of the device 206, to a location associated with the hardware interface 104-2 with which indicator 306-2 is associated. This can be seen in FIG. 11D in which the transference of the data object “Aud2.MP3” from the internal memory 206 to the memory card is illustrated on the display 102. According to some exemplary embodiments, the controller 206 may be responsive to detecting that the dynamic touch input has been completed, by asking the user to provide an input indicating whether they require the data object to be transferred before transferring the object.

According to some exemplary embodiments of the third aspect, only the indicators 306 which are associated with a possible destination for the selected data object may be displayed. As such, in the example of FIGS. 11A to 11D, as the data object is a .MP3 file (i.e. an audio file) only the indicators 306-1, 306-2 associated with the audio output socket 104-1 and the memory card slot 104-2 are displayed.

According to alternative embodiments, indicators 306 may be displayed regardless of whether the hardware interface with which they are associated is a possible destination for the data object. For example, an indicator associated with the battery charger socket 104-4 may be displayed even though that indicator does not represent a possible destination for the data object. In such embodiments, those indicators which represent possible destinations for the data object may be highlighted to the user as available by applying a different brightness or colour to the indicators. For example, indicators associated with unavailable destinations may be caused to appear to the user as less bright than indicators relating to available destinations.

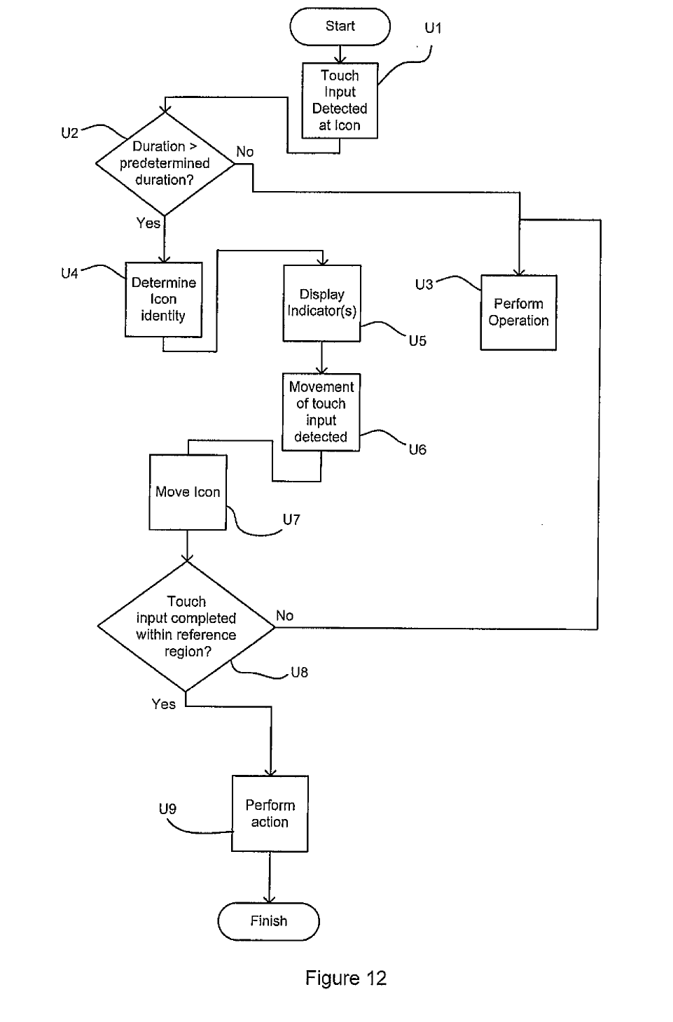

FIG. 12 is a flowchart depicting operations according to the third exemplary aspect of the invention.

In step U1, the controller 204 detects, based on signals received from the touch-sensitive display 102, the incidence of a touch input on the touch-sensitive display 102 at a location of the display 102 on which an icon 1100 is displayed.

Next, in step U2, the controller 204 determines if the duration of the touch input has exceeded a predetermined duration.

Following a negative determination in step U2, the operation proceeds to step U3, in which the controller 204 causes an operation to be performed. The nature of the operation of step U3 is not important to the invention.

Subsequent to a positive determination in step U2, the operation proceeds to step U4. In step U4, the controller identifies a data object associated with the icon 1100 on which the touch input is incident.

Next, in step U5, on the basis of the identification of step U4, the controller causes the one or more indicators 306 to be displayed. Each of the indicators 306 is associated with a hardware interface 104 of the device 100. The indicator 306 or indicators 306 which are caused to be displayed are those which are associated with hardware interfaces which are associated with possible destinations for the data object. Alternatively, plural indicators 306, some representing hardware interfaces 104 which are associated with allowed destinations for the data object, and some representing hardware interfaces 104 which are associated with disallowed destinations for the data objects. Those indicators 306 which represent interfaces 104 which are associated with allowed destinations for the data object may be graphically distinguished from those indicators 306 which represent interfaces 104 associated with disallowed destinations for the data object.

According to some alternative embodiments, step U4 may be omitted and step U5 may include displaying plural indicators 306 regardless whether or not they represent interfaces 104 which are associated with allowed destinations for, the data object.

Next, in step U6, the controller 204 detects that the touch input has become a dynamic touch input (i.e. that the user has moved their finger across the surface of the display). In response to step U6, the controller 204, in step U7, causes the icon 1100 to be moved or dragged across the display 102 in the direction of the dynamic touch input.

Next, in step U8, it is determined if the dynamic tactile input is completed within a region of the display 102 at which one of the indicators 306 is displayed. In other words, the controller 204 determines if the location on the display 102 to which the user's finger was incident immediately prior to it being removed from the display 102 falls within a region 304 of the display at which an indicator 306 is displayed. This region may comprise the whole area at which the icon is displayed or just a part of the area at which the indicator 306 is displayed.

Following a positive determination in step U8, the operation proceeds to step U9 in which the controller 204 causes an operation to be performed in respect of a data object associated with the icon selected in step U1. This may include, for example, copying or transferring the data object between two locations, which may be on a different or the same memory. Subsequent to step U9, the operation finishes.

If it is determined in step U8 that the touch input is completed at a location that does not fall within a region at which an indicator 306 is displayed, the operation proceeds to step U3. Subsequent to step U3, the operation finishes.

The third exemplary aspect of the invention allows a user to view statuses associated with hardware interfaces and subsequently easily to move data objects between locations on the portable device. This may be useful, for example, when a device has more than one memory card because it allows a user, for example, to view an amount of free space that remains on each of the memory cards and subsequently to move a data object to one or other of them dependent on the amount of free space remaining. Normally, this requires navigation of complex menu systems. As such, these embodiments allow a user to access information and functions with lower utilization of the hardware, particular user interface hardware, of the device 100. This can improve the reliability of the hardware and prolong its life.

The above described embodiments have been described with reference to a mobile phone. However, the invention is applicable to any electronic device, such as a portable device, comprising a touchscreen display and at least one hardware interface. Such devices include, but are not limited to, media players, navigation devices and cameras. Also, although the above-described embodiments have been described with reference to touch inputs being incident to a touch-sensitive display, the touch sensitive display may be operable also to detect the presence of a finger a small distance above the surface of the display. As such, a touch input may include any input which is detectable by a touch-sensitive display.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A method comprising responding to a detection of a first touch input, the first touch input being at a location on a touch-sensitive display of a device within a reference region of the touch-sensitive display associated with a hardware interface of the device, by causing an indicator associated with the hardware interface to be displayed at least partially within the reference region.

2. The method of claim 1, wherein the indicator includes first status information associated with the hardware interface.

3. The method of claim 2, further comprising responding to detection of a tactile event in respect of the indicator by causing second status information associated with the hardware interface to be displayed on the touch-sensitive display.

4. The method of claim 1, further comprising responding to detection of a dynamic touch input starting at a location on the touch-sensitive display corresponding to an icon associated with a data object displayed on the touch-sensitive display and finishing within the reference region by causing an action to be performed in respect of the data object.

5. Apparatus comprising at least one processor and at least one non-transitory computer-readable memory medium having stored thereon computer-readable code which, when executed by the at least one processor, causes the apparatus to be responsive to a detection of a first touch input, the first touch input being at a location on a touch-sensitive display of a device within a reference region of the touch-sensitive display associated with a hardware interface of the device, to cause an indicator associated with the hardware interface to be displayed at least partially within the reference region.

6. Apparatus as in claim 5, wherein the indicator includes at least one of an icon associated with the hardware interface and first status information associated with the hardware interface.

7. (canceled)

8. Apparatus as in claim 5, wherein the indicator includes first status information associated with the hardware interface and wherein the computer-readable code, when executed by the at least one processor, causes the apparatus to be responsive to a detection of a tactile event in respect of the indicator to cause second status information associated with the hardware interface to be displayed on the touch-sensitive display.

9. Apparatus as in claim 8, wherein the tactile event comprises the first touch input being incident at the location corresponding to a location of the indicator for longer than a predetermined period of time or wherein the tactile event comprises an incidence of a second touch input at a location corresponding to a location of the indicator within a predetermined period of time after detection of the first touch input.

10. (canceled)

11. Apparatus as in claim 5, wherein the computer-readable code, when executed by the at least one processor, causes the apparatus to be responsive to a detection of a dynamic touch input starting at a location on the touch-sensitive display corresponding to an icon associated with a data object displayed on the touch-sensitive display and finishing within the reference region to cause an action to be performed in respect of the data object.

12. Apparatus as in claim 11, wherein the action comprises one of transferring and copying the data object from a current storage location to a destination storage location associated with the hardware interface.

13. Apparatus as in claim 5, comprising a hardware interface and wherein a location of the reference region on the touch-sensitive display corresponds to a location of the hardware interface.

14. Apparatus as in claim 13, wherein the reference region is at a location on the touch-sensitive display that is most proximate to a physical location of the hardware interface.

15. Apparatus as in claim 5, wherein the reference region is at an edge of the touch-sensitive display.

16. Apparatus as in claim 5 wherein the computer-readable code, when executed by the at least one processor, causes the apparatus to be responsive to the detection of the first touch input at a location on the touch-sensitive display within one of plural reference regions, each of the plural reference regions being associated with a different one of plural hardware interfaces of the device, to cause an indicator associated with the hardware interface to be displayed in the one of the plural reference regions.

17. Apparatus as in claim 5, wherein the computer-readable code, when executed by the at least one processor, causes the apparatus to be responsive to the detection of the first touch input at a location on the touch-sensitive display within one of plural reference regions to cause plural indicators to be displayed, each reference region being associated with a different one of plural hardware interfaces of the device, each of the plural indicators being associated with a different one of the plural hardware interfaces and being displayed at least partially within the one of the reference regions with which the one of the plural hardware interfaces is associated.

18. Apparatus as in claim 5, wherein the apparatus is a portable device further comprising a touch-sensitive display.

19. A non-transitory computer-readable storage medium having stored thereon computer-readable code, which, when executed by computing apparatus, causes the computing apparatus:
to respond to a detection of a first touch input, the first touch input being at a location on a touch-sensitive display of a device within a reference region of the touch-sensitive display associated with a hardware interface of the device, by causing an indicator associated with the hardware interface to be displayed at least partially within the reference region.

20-29. (canceled)

30. Apparatus comprising at least one processor and at least one non-transitory computer-readable memory medium having stored thereon computer-readable code, which, when executed by the at least one processor, causes the apparatus:
to be responsive to a detection of a first touch input, the first touch input being at a first location on a touch-sensitive display at which an icon is displayed, to cause an indicator associated with a hardware interface to be displayed on the display at least partially within a reference region associated with the hardware interface, the icon representing a data object; and
subsequently, to be responsive to a detection that the first touch input is a dynamic touch input finishing at a second location, the second location being a location of the display at which the indicator is displayed, to cause an action to be performed in respect of the data object.

31. (canceled)

32. The apparatus of claim 30, wherein the action comprises copying or transferring the data object from a current storage location to a destination storage location, the destination storage location being associated with the hardware interface.

33. The apparatus of claim 32 wherein the computer-readable code, when executed by the at least one processor, causes the apparatus:
prior to causing the indicator to be displayed, to identify a type of the data object; and
to select the indicator based on a determination that the hardware interface, with which the indicator is associated, is associated with a destination storage location that is allowed for a data object of type identified.

34. The apparatus of claim 30, wherein the computer-readable code, when executed by the at least one processor, causes the apparatus to display the indicator only if it is determined that the first touch input was incident at the first location for a time exceeding a predetermined duration.

35-36. (canceled)
